(19) United States
(12) Patent Application Publication
(10) Pub. No.: US 2025/0135757 A1
(43) Pub. Date: May 1, 2025

(54) FILM STRUCTURES HAVING IMPROVED OPTICAL PROPERTIES

(71) Applicant: AMCOR FLEXIBLES NORTH AMERICA, INC., Neenah, WI (US)

(72) Inventors: Philipp OKLE, Konstanz (DE); Peter ETTRIDGE, Worcester (GB); Erik BOGELS, Lanaken (BE)

(21) Appl. No.: 18/837,644

(22) PCT Filed: Mar. 3, 2023
(86) PCT No.: PCT/US2023/014428

§ 371 Date: Aug. 12, 2024

Related U.S. Application Data
(60) Provisional application No. 63/320,537, filed on Mar. 16, 2022.

(51) Int. Cl. B32B 27/08

(52) U.S. Cl. CPC B32B 27/08; B32B 2255/10; B32B 2255/20; B32B 2307/412; B32B 2307/418; B32B 2307/514; B32B 2307/54; B32B 2307/7376

(57) ABSTRACT

Film structures and methods of forming a film structure are described herein. The film structure includes a polymeric substrate having an inorganic coating thereon. The film structure has a polymeric buffer layer positioned between the polymeric substrate and the inorganic coating. The inorganic coating comprises a wave structure characterized by an average amplitude in a range of from 0.1 μm to 5 μm and a wavelength in a range of from 0.3 μm to 15 μm. The inventors have advantageously discovered that the wave structure of the inorganic coating exhibits improved optical properties (e.g., light refraction). The film structures described herein may be used in greenhouse screens.

### TECHNICAL FIELD

Embodiments of the disclosure generally relate to film structures and methods to produce the film structures. More particularly, embodiments of the present invention are directed to film structures that exhibit high light transmittance, among other improved optical properties.

### BACKGROUND

Imparting anti-reflective optical properties in films is desirable for a number of reasons. Typically, anti-reflective optical properties are imparted by applying an anti-reflective coating on top of a substrate. The anti-reflective coating typically contains nano-particles. In typical anti-reflective coatings, anti-reflective properties are imparted by introducing new interfaces and the effective refractive index (RI) of the nano-particle coating being lower than that of the substrate. These newly introduced interfaces often form a gradient of refractive indexes, where the refractive index is increasing from air to substrate. Well homogenized nano-particles, which have dimensions smaller than the wavelength of visible light, often show minimal interaction with the trajectory of light, thereby resulting in high clarity/low diffusivity anti-reflective films.

Other applications, such as window films, greenhouse screens, privacy filters, display films, and solar cell applications may benefit from a diffuse character causing the light to be widely refracted. Current methods include adding small, refracting (micro) particles (e.g., SiOx) to the window films, greenhouse screens, privacy filters, display films, and/or solar cell applications. However, the addition of small, refracting (micro) particles not only affects the diffuse character of the window films, greenhouse screens, privacy filters, display films, and/or solar cell applications, but also has a negative effect on the light transmission/transparency of the film because part of the light is widely refracted through the film and reflected in similar wide angles, causing loss in transmission. For example, common anti-reflective films often have high clarity when the anti-reflective film is glossy and/or smooth and is in direct contact with the contents, e.g., optical displays (QD or OLED TV, tablet, lap/desktop, smartphones).

Generally, light trapping with a structured surface (i.e., a film structure) is not uncommon. Examples of formation of wave-like wrinkle structures are disclosed in U.S. Pat. No. 10,680,193, and in articles such as Huang, Rui. “A Kinetics Approach to Surface Wrinkling of Elastic Thin Films” in Mechanical Self-Assembly, edited by Xi Chen, 69-109. New York, NY: Springer New York, 2013, available at https://doi.org/10.1007/978-1-4614-4562-3_5.

Without contesting the associated advantages of the state-of-the-art systems, there exists a need for film structures that exhibit improved optical properties such as increased diffusivity, increased haze value, and increased light transmittance compared to known film structures.

### SUMMARY

Embodiments of the present invention advantageously provide a film structure comprising: a polymeric substrate having an inorganic coating thereon; and a polymeric buffer layer positioned between the polymeric substrate and the inorganic coating, wherein the inorganic coating comprises a wave structure characterized by an average amplitude in a range of from 0.1 μm to 5 μm and a wavelength in a range of from 0.3 μm to 15 μm.

In some embodiments, the polymeric substrate comprises one or more of polyethylene polymer, polypropylene polymer, polyethylene terephthalate polymer, polyethylene naphthalate polymer, polyamide polymer, polyvinyl chloride polymer, polylactic acid polymer, polyvinylidene fluoride polymer, polychlorotrifluoroethylene polymer or polybutylene succinate polymer. In some embodiments, the polymeric substrate comprises an oriented polyethylene film, an oriented polyester film, an oriented polyamide film, an oriented polylactic acid polymer film, a polyvinyl chloride film, a fluorinated polymer film or an oriented polybutylene succinate film.

In some embodiments, the polymeric substrate has a thickness in a range of from 5 μm to 100 μm. In some embodiments, the polymeric buffer layer has a thickness in a range of from 0.5 μm to 9 μm. In some embodiments, a ratio of the thickness of the polymeric buffer layer to the thickness of the inorganic coating is in the range of from 30 to 120.

In some embodiments, the polymeric buffer layer has a Young's Modulus in a range of 0.1 MPa to 100 MPa, as calculated from measurements collected at 95° C., according to ASTM E2546-15 with Annex X.4. In some embodiments, the polymeric buffer layer comprises one or more of a vinyl alcohol copolymer, a polyolefin-based polymer, a polyurethane-based polymer, an acrylic polymer, a polyester-based polymer, a polyepoxide-based polymer or polylactic acid.

In some embodiments, the inorganic coating has a thickness in a range of from 5 nm to 200 nm. In some embodiments, the inorganic coating comprises one or more of chromium, palladium, an oxide, a metal oxide, a nitride, or a metal nitride. In some embodiments, the inorganic coating comprises a metal oxide configured to block ultraviolet (UV) light. In some embodiments, the inorganic coating comprises silicon oxide. In some embodiments, the inorganic coating has a refractive index in a range of from 1.2 to 5.

In some embodiments, the inorganic coating comprises a wave structure characterized by an average amplitude in a range of from 0.1 μm to 5 μm and a wavelength in a range of from 0.3 μm to 15 μm. The inventors have surprisingly found that the wave structure of the inorganic coating exhibits numerous improved optical properties. In some embodiments, the wave structure of the inorganic coating refracts light. In some embodiments, the wave structure comprises a plurality of waves formed in one or more of a machine direction or a transverse direction.

In some embodiments, when the inorganic coating has the wave structure, the film structure has a transparency of at least 85% measured using the method disclosed in ASTM D-1003. In some embodiments, when the inorganic coating has the wave structure, wherein the film structure has a haze value of at least 60% measured using the method disclosed in ASTM D-1003.

In some embodiments, the film structure further comprises a lacquer on a surface of the inorganic coating. In some embodiments, the lacquer has a thickness in a range of from 0.1 μm to 0.95 μm or from 0.5 μm to 0.9 μm. In some embodiments, when the lacquer is on top of the inorganic coating, the lacquer comprises a wave structure.

In some embodiments, the polymeric buffer layer is a first polymeric buffer layer, and the lacquer comprises a second polymeric buffer layer. In some embodiments, the second polymeric buffer layer of the lacquer has the same properties as the first polymeric buffer layer.

Additional embodiments of the disclosure advantageously provide a method of forming a film structure. In some embodiments, the method comprises providing a polymeric substrate having a shrink onset temperature at which the polymeric substrate has a free shrink of at least 0.5% in at least one of a machine direction or a transverse direction when measured according to ASTM D2732, positioning a polymeric buffer layer on a surface of the polymeric substrate, positioning an inorganic coating on a surface of the polymeric buffer layer such that the polymeric buffer layer is between the polymeric substrate and the inorganic coating, and heating the polymeric substrate to a temperature above the shrink onset temperature to impart a wave structure to the inorganic coating, the wave structure of the inorganic coating characterized by an average amplitude in a range of from 0.1 μm to 5 μm and a wavelength in a range of from 0.3 μm to 15 μm. In some embodiments, the wave structure comprises a plurality of waves formed in one or more of a machine direction or a transverse direction.

The inventors have surprisingly found that heating the polymeric substrate imparts the wave structure to the polymeric buffer layer and the inorganic coating. In some embodiments, heating the polymeric substrate comprises heating at a temperature in a range of from 150° C. to 210° C. for at least 5 minutes. In some embodiments, heating the polymeric substrate comprises a roll-to-roll process having exposure to heated rolls for a period of time of roughly one minute.

The inventors have surprisingly found that the film structures described herein, which may be useful in barrier packaging films and retortable packaging applications, have several other useful applications.

The inventors have surprisingly found that the wave structure of the inorganic coating exhibits numerous improved optical properties compared to other film structures. In some embodiments, the wave structure of the inorganic coating refracts light. In some embodiments, the wave structure of the inorganic coating comprises a metal oxide that is configured to block ultraviolet (UV) light.

In some embodiments, when the inorganic coating has the wave structure, the film structure has a transparency of at least 85% measured using the method disclosed in ASTM D-1003. In some embodiments, when the inorganic coating has the wave structure, wherein the film structure has a haze value of at least 60% measured using the method disclosed in ASTM D-1003.

For greenhouse applications, diffuse light prevents localized scorching of plants from direct intense sunlight and allows the even spread of light across a greenhouse. During a northern European winter, as an example, the sun is low in the sky and light levels are generally low. A highly diffuse screen allows the low incident light to be diffused across the greenhouse, not only in the area of direct light incidence. The film structures described herein, which have high light transmittance, may, advantageously, refract the highly diffuse light from the sun to improve the total flux of light arriving across the growing plants in a greenhouse, thereby improving growing efficiency.

### BRIEF DESCRIPTION OF THE DRAWINGS

The disclosure may be more completely understood in consideration of the following detailed description of various embodiments of the disclosure in connection with the accompanying drawings, in which:

FIGS. 1 and 2 illustrate cross-sectional views of embodiments of precursory film structures;

FIGS. 3 and 4 illustrate cross-sectional views of embodiments of film structures;

FIG. 5 is a flowchart of a method of forming a film structure according to one or more embodiments of the disclosure;

FIG. 6 is a top-view of a magnification of a wave structure formed in one or more embodiments of a film structure;

FIGS. 7A, 7B and 7C are enlarged micrographs of the top view of film structures which formed waves (7A and 7C) and a comparative film structure that does not form waves (7B). The micrographs illustrated in FIGS. 7A, 7B and 7C are not at the same magnification; and

FIGS. 8A, 8B, 8C and 8D are plots of BSDF (bidirectional scattering distribution function) as a function of angle of incidence at 630 nm for an example film (8C and 8D) and a reference film (8A and 8B).

The drawings show some but not all embodiments. The elements depicted in the drawings are illustrative and not necessarily to scale, and the same (or similar) reference numbers denote the same (or similar) features throughout the drawings.

### DETAILED DESCRIPTION

Embodiments of the present invention advantageously provide film structures and methods of forming film structures. The film structures described herein have a polymeric substrate having an inorganic coating thereon; and a polymeric buffer layer (e.g., a first polymeric buffer layer) positioned between the polymeric substrate and the inorganic coating, wherein the inorganic coating comprises a wave structure characterized by an average amplitude in a range of from 0.1 μm to 5 μm and a wavelength in a range of from 0.3 μm to 15 μm.

In some embodiments, the film structure further comprises a lacquer on top of the inorganic coating. In some embodiments, the polymeric buffer layer is a first polymeric buffer layer, and the lacquer comprises a second polymeric buffer layer. In some embodiments, the second polymeric buffer layer of the lacquer has the same properties as the first polymeric buffer layer.

During exposure to temperatures high enough to cause the film structure to shrink, the polymeric buffer layer is configured to be a malleable interface between the shrinking polymeric substrate and the stiff, non-shrinking inorganic coating, allowing a continuous wave structure to form within the inorganic coating at the surface of the polymeric buffer layer. In some embodiments, formation of the continuous wave structure substantially reduces the number of cracks within the inorganic coating.

In some embodiments, the wave structure formation effect of the inorganic coating on the polymeric buffer layer is obtained by a subtle equilibrium between 1) polymeric buffer layer thickness, 2) elastic modulus of the polymeric buffer material at the heat treatment temperature and 3) the thickness of the inorganic coating. The wave structure formation is also affected by the directional shrinkage behavior of the polymeric substrate, resulting in waves that travel in the direction of the shrink. At and above the temperature at which the polymeric substrate begins to shrink (i.e., the heat treatment temperature, the shrink onset temperature), the polymeric buffer layer must have a modulus such that it can change shape. The shape change is a result of a shrinking surface area on the side of the polymeric buffer layer nearest the shrinking polymeric substrate and the non-shrinking surface area on the side of the polymeric buffer layer adjacent the inorganic coating. Due to its low modulus, the surface of the polymeric buffer layer adjacent to the polymeric substrate can move and adjust to the shrinking force. The polymeric buffer layer adjacent to the inorganic coating conforms to a wave structure to accommodate for the unchanging surface area of the inorganic coating. The wave structure of the inorganic coating may form in one or more patterns, including but not limited to regular (i.e., stripes), herringbone and random (i.e., labyrinths). The formation of the wave structure allows the inorganic coating to flex, retaining its original surface area and remaining intact, without cracks (or without as many cracks). Generally, the wave structure forms in the direction of the shrinking. The pliability and movement of the polymeric buffer layer allows the inorganic coating to flex into a wave structure, retaining its original surface area.

Without being limited to any particular embodiment, a model used to describe the theoretical formation of waves in various systems can be found in articles such as Huang, ZY, Hong, W, Suo Z 2005, ‘Nonlinear Analysis of Wrinkles in a Film Bonded to a Compliant Substrate’, Journal of the Mechanics and Physics of Solids, 53, 2101-2118.

Additional embodiments of the present invention advantageously provide a method of forming a film structure, the method comprising 1) providing a polymeric substrate having a shrink onset temperature at which the polymeric substrate has a free shrink of at least 0.5% in at least one of a machine direction or a transverse direction when measured according to ASTM D2732, 2) positioning a polymeric buffer layer on a surface of the polymeric substrate, 3) positioning an inorganic coating on a surface of the polymeric buffer layer such that the polymeric buffer layer is between the polymeric substrate and the inorganic coating; and 4) heating the polymeric substrate to a temperature above the shrink onset temperature to impart a wave structure to the inorganic coating, the wave structure of the inorganic coating characterized by an average amplitude in a range of from 0.1 μm to 5 μm and a wavelength in a range of from 0.3 μm to 15 μm.

In some embodiments, the method further comprises positioning a lacquer on a surface of the inorganic coating. In some embodiments, the polymeric buffer layer is a first polymeric buffer layer, and the lacquer comprises a second polymeric buffer layer. In some embodiments, the second polymeric buffer layer of the lacquer has the same properties as the first polymeric buffer layer.

As used in this disclosure and the appended claims, the following terms are provided with the definitions outlined below.

“Polymeric Buffer Layer” as used herein is a layer within the film structure, directly adjacent to and in contact with the inorganic coating, having the function of allowing the inorganic coating to flex from a relatively flat cross-sectional geometry into a wave structure. The polymeric buffer layer is formulated such that the material or blend of materials becomes malleable in the temperature range at which the film structure experiences slight shrinking due to thermal exposure (e.g., 95° C.), as is further described herein. The formula of the polymeric buffer layer can be directed toward achieving an elastic modulus in the appropriate temperature range (i.e., the temperature range in which film shrinking occurs, the shrink onset temperature) that allows the material to be pliable.

“Shrink Onset Temperature” as used herein is the temperature at which the durable barrier film demonstrates a free shrink of at least 0.5% in at least one of the machine direction (MD) or the transverse direction (TD). “Free Shrink” as used herein is an unrestrained linear shrinkage that a film or layer undergoes due to exposure to elevated temperature. The shrink is irreversible and relatively rapid (i.e., evident within seconds or minutes). Free shrink is expressed as a percentage of the original dimension, (i.e., 100×(pre-shrink dimension−post-shrink dimension)/(pre-shrink dimension)). Free shrink can be measured using ASTM D2732. Alternatively, free shrink can be measured by using the test method described in ASTM D2732 with a modification of using hot air as the heating source instead of a hot fluid bath. If using the hot air method, place the unrestrained sample in the oven set at the specified temperature for a time span of at least 1 minute, giving the oven interior and sample ample time to come to thermal equilibrium. To determine the shrink onset temperature, perform the free shrink test at 10° C. increasing increments until the material shrinks at least 0.5% in one or both of the machine direction and the transverse direction. The temperature at which the free shrink is at least 0.5% in at least one direction (MD or TD) is the shrink onset temperature. Practical shrink onset temperatures for the films described herein may be between 50° C. and 200° C.

As used herein, layers or films that are “in direct contact with” or “are directly adjacent to” each other have no intervening material between them.

“Inorganic Coating” as used herein refers to a layer that comprises one or more of an oxide, a metal oxide, a nitride, or a metal nitride. The inorganic coating may comprise a metal oxide configured to block ultraviolet (UV) light. The inorganic coating may be vacuum deposited (i.e., vacuum coated, vapor coated, vacuum metalized) directly on the surface of the polymeric buffer layer. Alternatively, the inorganic coating may be deposited by wet chemistry methods, such as solution coating.

As described herein, the polymeric substrate may be an oriented or unoriented film. The polymeric substrate may contain one or more of polyethylene polymer, polypropylene polymer, polyethylene terephthalate polymer, polyethylene naphthalate polymer, polyamide polymer, polyvinyl chloride polymer, polylactic acid polymer, polyvinylidene fluoride polymer, polychlorotrifluoroethylene polymer or polybutylene succinate polymer.

The polymeric substrate may be one or more of an oriented polyethylene (OPE) film, an oriented polyethylene terephthalate (OPET) film, an oriented polyethylene naphthalate (OPEN) film, an oriented polypropylene (OPP) film, a biaxially oriented polyethylene (BOPE) film, a biaxially oriented polyethylene terephthalate (BOPET) film, or a biaxially oriented polypropylene (BOPP) film. Orientation may be the result of monoaxially oriented (machine direction or transverse direction), or biaxially oriented (machine direction and transverse direction) stretching of the film structure, increasing the machine direction and/or transverse direction dimension and correspondingly decreasing the thickness of the material. In some embodiments, the polymeric substrate comprises one or more of a machine direction oriented polyethylene (MDOPE) film or a machine direction oriented polypropylene (MDOPP) film. Biaxial orientation may be imparted to the film structure simultaneously or successively. In some embodiments, the film structure is stretched in either or both directions at a temperature just below the melt temperature of the polymers in the film structure. In this manner, stretching causes the polymer chains to “orient”, changing the physical properties of the film structure. At the same time, stretching thins the film structure. In some embodiments, the resulting oriented films are thinner and can have significant changes in mechanical properties such as toughness, heat resistance, stiffness, and/or tear strength.

Orientation is typically accomplished by a double- or triple-bubble process, by a tenter-frame process or an MDO process using heated rolls. A typical blown film process or cast film process may impart a very small amount of melt-phase stretching of the film structure, but not enough to be considered oriented as described herein. An oriented film may be heat set (i.e., annealed) after orientation, such that the film is relatively dimensionally stable under elevated temperature conditions that might be experienced during conversion of the film laminate (i.e., printing or laminating) or during the use of the laminate (i.e., heat sealing or retort sterilization). As used herein, the terms “unoriented” and “non-oriented” refer to a monolayer or multilayer film, sheet or web that is substantially free of post-extrusion orientation.

As used herein, the term “polyolefin”, “polyolefin polymer” or “polyolefin-based polymer” generally includes polypropylene and polyethylene polymers.

As used throughout this application, the term “copolymer” refers to a polymer product obtained by the polymerization reaction or copolymerization of at least two monomer species. The term “copolymer” is also inclusive of the polymerization reaction of three, four or more monomer species having reaction products referred to terpolymers, quaterpolymers, etc.

As used throughout this application, the term “polypropylene”, “polypropylene-based polymer” or “PP” refers to, unless indicated otherwise, propylene homopolymers or copolymers. Such copolymers of propylene include copolymers of propylene with at least one alpha-olefin and copolymers of propylene with other units or groups. The term “polypropylene” or “PP” is used without regard to the presence or absence of substituent branch groups or other modifiers. Polypropylene includes, but is not limited to, homopolymer polypropylene, polypropylene impact copolymer, polypropylene random copolymer, propylene-ethylene copolymers, ethylene-propylene copolymers, maleic anhydride grafted polypropylenes and blends of such. Various polypropylene polymers may be recycled as reclaimed polypropylene or reclaimed polyolefin.

As used throughout this application, the term “polyethylene”, “polyethylene-based polymer” or “PE” refers to, unless indicated otherwise, ethylene homopolymers or copolymers. Such copolymers of ethylene include copolymers of ethylene with at least one alpha-olefin and copolymers of ethylene with other units or groups such as vinyl acetate, acid groups, acrylate groups, or otherwise. The term “polyethylene” or “PE” is used without regard to the presence or absence of substituent branch groups. Polyethylene includes, but is not limited to, medium density polyethylene, high density polyethylene, low density polyethylene, linear low-density polyethylene, ultra-low density polyethylene, ethylene alpha-olefin copolymer, ethylene vinyl acetate, ethylene acid copolymers, ethylene acrylate copolymers, neutralized ethylene copolymers such as ionomer, maleic anhydride grafted polyethylene and blends of such. Various polyethylene polymers may be recycled as reclaimed polyethylene or reclaimed polyolefin.

As used throughout this application, the term “polyethylene terephthalate polymer”, “polyester”, “polyester-based polymer” or “PET” refers to a homopolymer or copolymer having an ester linkage between monomer units. The ester linkage may be represented by the general formula [O—R—OC(O)—R′—C(O)]ₙ where R and R′ are the same or different alkyl (or aryl) group and may generally be formed from the polymerization of dicarboxylic acid and diol monomers.

As used herein, “polyurethane”, “polyurethane polymer” or “polyurethan-based polymer” is generally referencing polymers having organic units joined by urethane links (—NH—(C═O)—O—).

As used herein, “polylactic acid” or “polylactic acid polymer” is a polymer made from lactic acid and having a backbone of [—C(CH₃)HC(═O)O-]ₙ.

As used throughout this application, the term “acrylic polymer” refers to polymers comprised of repeating units of acrylate functional groups.

As used throughout this application, the term “vinyl alcohol copolymer” refers to film forming copolymers of vinyl alcohol (CH₂CHOH). Examples include, but are not limited to, ethylene vinyl alcohol copolymer (EVOH), butenediol vinyl alcohol copolymer (BVOH), and polyvinyl alcohol (PVOH).

As used throughout this application, the term “ethylene vinyl alcohol copolymer”, “EVOH copolymer” or “EVOH” refers to copolymers comprised of repeating units of ethylene and vinyl alcohol. Ethylene vinyl alcohol copolymers may be represented by the general formula: [(CH₂—CH₂)ₙ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene.

As used throughout this application, the term “polyepoxide-based polymer” refers to polymers comprised of repeating units of epoxide resin monomers.

The term “layer”, as used herein, refers to a building block of a film that is a structure of a single material type or a homogeneous blend of materials. A layer may be a single polymer, a blend of materials within a single polymer type or a blend of various polymers, may contain metallic materials and may have additives. Layers may be continuous with the film or may be discontinuous or patterned. A layer has a relatively insignificant thickness (z direction) as compared to the length and width (x-y direction), and therefore is defined to have two major surfaces, the area of which are defined by the length and width of the layer. An exterior layer is one that is connected to another layer at only one of the major surfaces. In other words, one major surface of an exterior layer is exposed. An interior layer is one that is connected to another layer at both major surfaces. In other words, an interior layer is between two other layers. A layer may have sub-layers.

Similarly, the term “film” or “film structure”, as used herein, refers to a web built of layers and/or films, all of which are directly adjacent to and connected to each other. A film can be described as having a thickness that is relatively insignificant as compared to the length and width of the film. A film has two major surfaces, the area of which are defined by the length and width of the film.

As used herein, the term “exterior” is used to describe a film or layer that is located on one of the major surfaces of the film in which it is comprised. As used herein, the term “interior” is used to describe a film or layer that is not located on the surface of the film in which it is comprised. An interior film or layer is adjacent to another film or layer on both sides.

“Wave structure” as used herein refers to a cross-sectional geometry of the inorganic coating and the surface of the adjacent polymeric buffer layer(s). As with any wave, the wave structure has a wavelength, measurable in the x-y direction, and an amplitude, measurable in the z-direction.

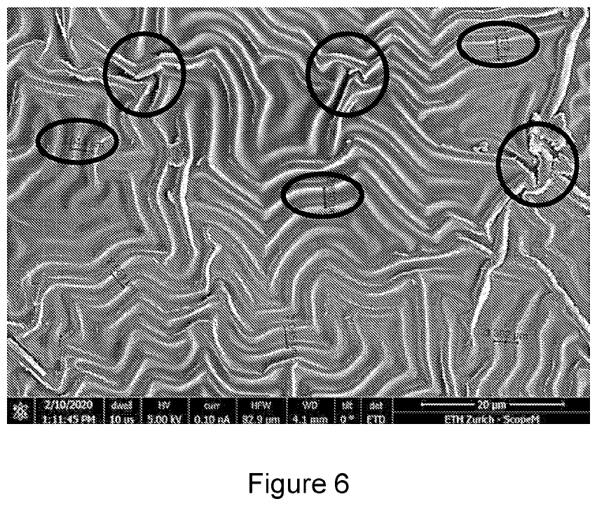

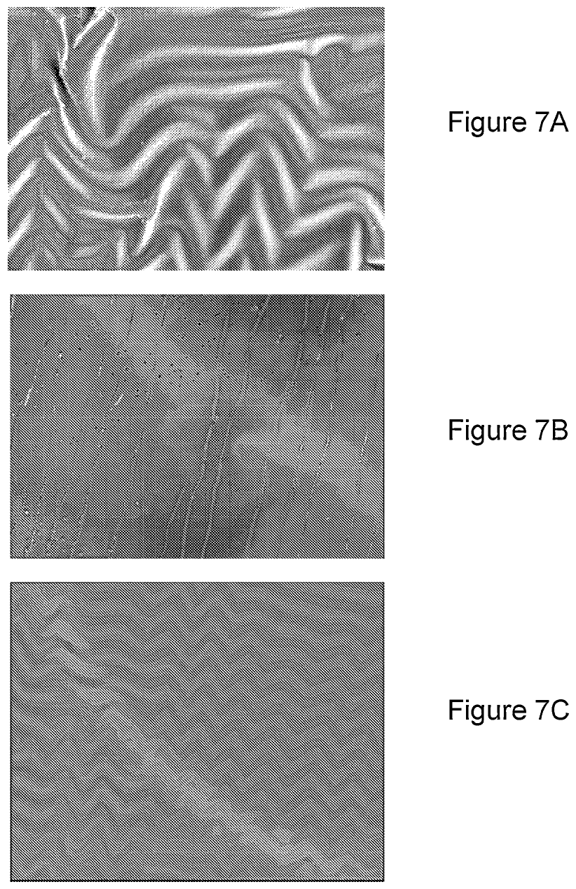

The wavelength of the wave structure can be determined using top view microscopy techniques including, but not limited to, optical microscopy, laser scanning microscopy, electron microscopy, or atomic force microscopy. The resolution of the microscope needs to be sufficient to identify features on the waves, such as wave peaks and wave valleys. An example of a representative top view microscopy is shown in FIG. 6. As shown in this view, the waves take various patterns and are organized into wave domains, or sections where the waves are regular and ordered. The wave domains meet at corners or edges and form irregular folds or intersections. Measurements of the waves can be executed in the wave domains, examples of which are indicated by superimposed ovals. Variations in wave measurements can occur at the intersections, examples of which are indicated by superimposed circles, as the colliding waves interfere with the regular pattern. The areas including intersections of waves are not used for wave measurements.

The wavelength is the distance between either peak to peak or valley to valley in an undistorted area of waves (i.e., wave domain). An average wavelength is calculated by taking the average of at least 5 individual wavelength measurements.

Other techniques to determine the wavelength are possible. For example, the wavelength may be measured using a cross-sectional view of the wave structure. Another option would be to measure it in an optical setup, using the waves as a grating. The resulting spectrum of a light shining through the film may be used to determine the wavelength.

The amplitude of a wave structure (i.e., the distance from valley to peak of a wave) can be assessed on a film using a z-direction information sensitive microscope. For example, the microscope may be a laser scanning microscope or an atomic force microscope. In some embodiments, the resolution in the z-direction may be at least as small as the tens of nanometers range.

In some embodiments of the film, the amplitude can be determined on a cut cross-section (i.e., microtome cut, embedded in epoxy and polished, or other routes) in a microscope with appropriate resolution and contrast.

As used herein, the “average amplitude” is determined by measurement of the amplitude of at least five individual waves using one or more positions across the film sample in undistorted areas (i.e., wave domains) and calculating the average of these five measurements.

As used herein, “barrier” or “barrier film” or “barrier layer” or “barrier material” refers to providing for reduced transmission to gases such as oxygen (i.e., containing an oxygen barrier material). The barrier material may provide reduced transmission to moisture (i.e., containing a moisture barrier material). The barrier characteristic may be provided by one or more barrier materials, or a blend of multiple barrier materials.

As used herein, the “Young's modulus” or “elastic modulus” or “modulus” is a measure of a materials ability to change dimension when under tensile or compressive force, in units of force per unit area. A material with a higher Young's modulus may be relatively stiff while a material with a lower Young's modulus is relative soft and pliable (i.e., elastic). Young's modulus can be calculated from a force-displacement data set derived from a nanoindentation test procedure.

As used herein, “ASTM E2546-15 Annex X.4” refers to an instrumented indentation test procedure according to the documented standard using an apparatus including a silicon tip mounted on a silicon cantilever with a defined tip radius of 30 nm.

As used herein, “ASTM D-1003” refers to a standard test method for measuring haze and luminous transmittance of transparent plastics. ASTM D-1003 includes two procedures (e.g., Procedure A and Procedure B) for the measurement of luminous transmittance and haze. Procedure A uses a haze meter and Procedure B uses a spectrophotometer. As described in ASTM D-1003, material having a haze value greater than 30% is considered diffusing and should be tested in accordance with Practice E2387.

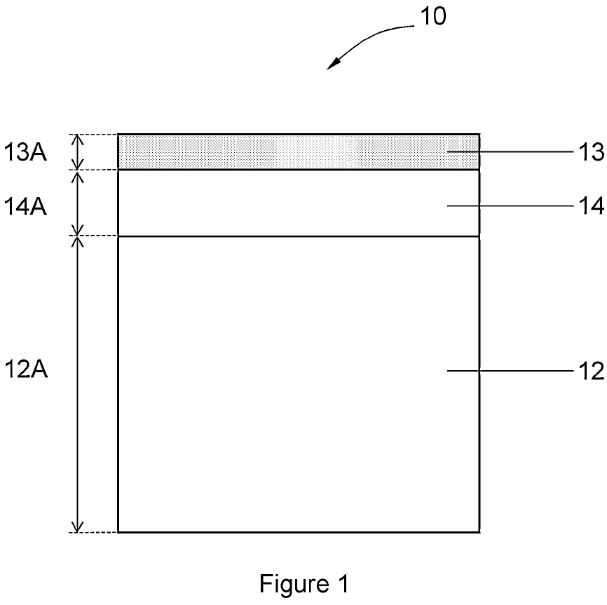

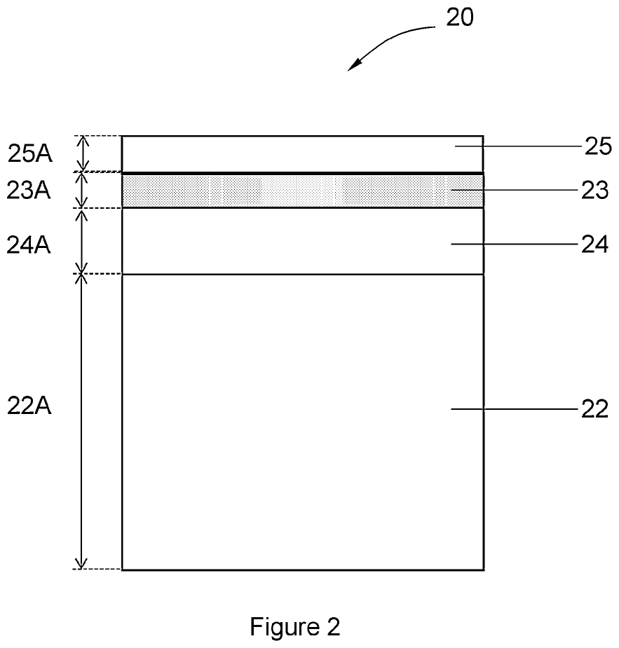

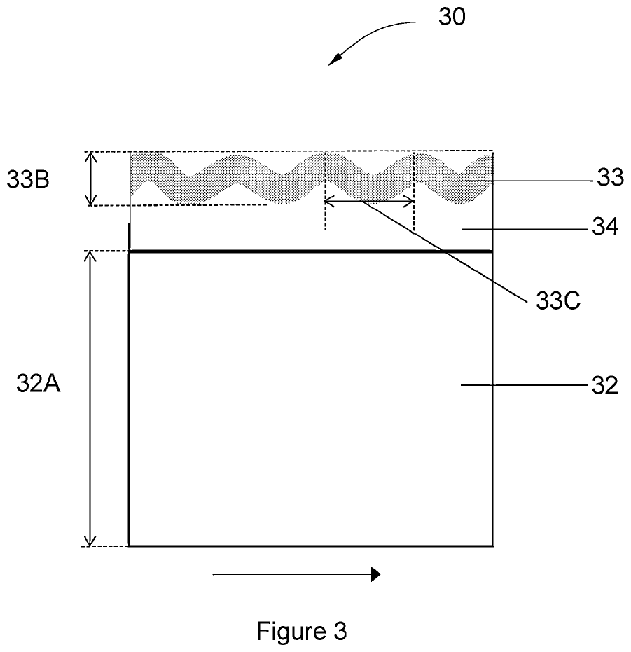

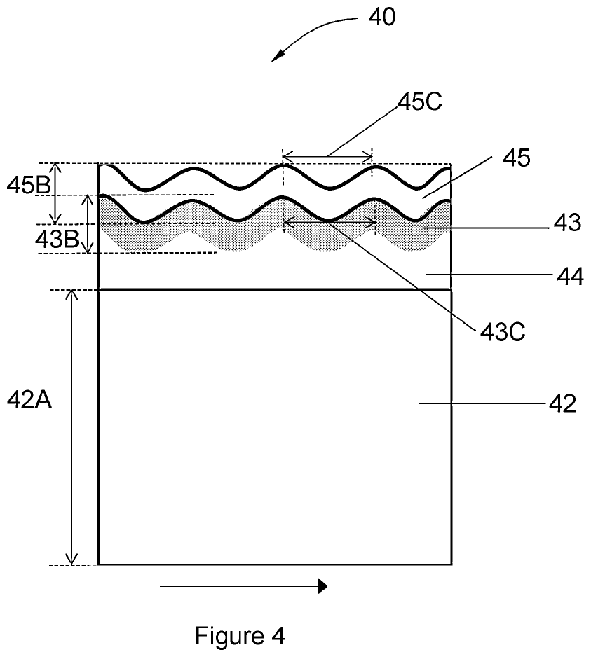

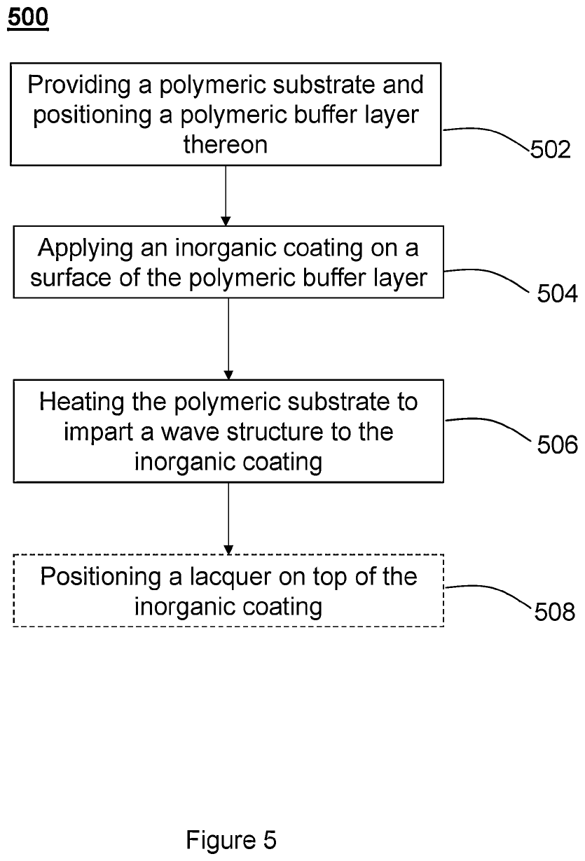

Embodiments of a precursory film structure (i.e., a film structure prior to formation of the wave structure) are illustrated in FIGS. 1 and 2, and embodiments of a film structure are shown in FIGS. 3 and 4. While embodiments of the film structure may be described with reference to FIGS. 1-4, one or more aspects of the film structure may have the same properties as its corresponding feature in a different figure. For example, the polymeric substrate 12 of film structure 10 may have the same properties as the polymeric substrate 22 of film structure 20. A flowchart of a method 500 of forming a film structure is illustrated in FIG. 5. Without being limited to any particular embodiment, the method 500 may be used to form embodiments of the film structure illustrated in any of FIGS. 3 and 4.

FIG. 1 shows a cross-sectional view of a precursory film structure 10. The precursory film structure 10 includes a polymeric substrate 12, an inorganic coating 13 and a polymeric buffer layer 14 positioned between the polymeric substrate 12 and the inorganic coating 13. In some embodiments, the polymeric buffer layer 14 is in direct contact with the inorganic coating 13. In some embodiments, the polymeric buffer layer 14 may be in direct contact with the polymeric substrate 12, as shown in FIG. 1, or there may be one or more additional layers between the polymeric buffer layer 14 and the polymeric substrate 12. The polymeric substrate 12 forms an exterior layer of the precursory film structure 10 and the inorganic coating 13 forms the opposing exterior layer of the precursory film structure 10.

FIG. 2 illustrates a cross-sectional view of another embodiment of a precursory film structure 20. In FIG. 2, the precursory film structure 20 includes a polymeric substrate 22, an inorganic coating 23 and a polymeric buffer layer 24 (e.g., a first polymeric buffer layer) positioned between the polymeric substrate 22 and the inorganic coating 23. In some embodiments, the polymeric buffer layer 24 (e.g., a first polymeric buffer layer) is in direct contact with the inorganic coating 23. In some embodiments, the polymeric buffer layer 24 (e.g., a first polymeric buffer layer) may be in direct contact with the polymeric substrate 22, as shown in FIG. 2, or there may be one or more additional layers between the polymeric buffer layer 24 (e.g., a first polymeric buffer layer) and the polymeric substrate 22.

In FIG. 2, the precursory film structure 20 includes a lacquer 25 directly on the inorganic coating 23. In some embodiments, the lacquer 25 comprises a second polymeric buffer layer. In FIG. 2, the polymeric substrate 22 forms an exterior layer of the precursory film structure 20 and the lacquer 25 forms the opposing exterior layer of the precursory film structure 20.

In some embodiments, the second polymeric buffer layer of the lacquer 25 is in direct contact with the inorganic coating 23, opposite the first polymeric buffer layer 24. In some embodiments, the second polymeric buffer layer of the lacquer 25 has the same properties as the first polymeric buffer layer 24 in regard to one or more of the content, thickness and/or physical properties. In some embodiments, the second polymeric buffer layer of the lacquer 25 has different properties as compared to the first polymeric buffer layer 24.

While embodiments of the film structure may be described with reference to FIGS. 1-4, one or more aspects of the film structure may have the same properties as its corresponding feature in a different figure. For example, each of the polymeric substrates 12, 22, 32, and 42, may have the same properties.

In some embodiments, the polymeric substrate 12, 22, 32, 42 has a thickness 12A, 22A, 32A, 42A measured in the z-direction. In one or more embodiments, the polymeric substrate 12, 22, 32, 42 has a thickness 12A, 22A, 32A, 42A in a range of from 5 μm to 100 μm, in a range of from 10 μm to 75 μm, in a range of from 25 μm to 50 μm, or in a range of from 30 μm to 40 μm. Without intending to be bound by any particular theory of operation, the polymeric substrate 12, 22, 32, 42 may have substantially the same thickness 12A, 22A, 32A, 42A prior to shrinking and after shrinking. As used in this manner, “substantially the same thickness” means that the thickness 12A, 22A, 32A, 42A of the polymeric substrate 12, 22, 32, 42 may be less than or equal to 10%, less than or equal to 5%, less than or equal to 2.5%, less than or equal to 1%, or less than or equal to 0.5% different prior to shrinking as compared to after shrinking.

In some embodiments, the polymeric substrate has a free shrink value greater than or equal to 0.5% in at least one of the machine direction or the transverse direction at 95° C. The free shrink of the polymeric substrate at 95° C., or another suitable elevated processing temperature which the film structure is exposed, causes a decrease in the surface area of the polymeric substrate. It is believed that any layer adjacent to or near the shrinking polymeric substrate experiences a shrink force in the x-y direction, due to the reduction of surface area. It is believed that any layer attached to the shrinking polymeric substrate experiences a shrink force in the x-y direction, due to the reduction of surface area.

The free shrink of the polymeric substrate at 95° C. may be in a range of from 0.5% to 10%, in a range of from 0.5% to 8%, in a range of from 1% and 10% or in a range of from 1% to 6%. The free shrink of the polymeric substrate may be measured on the polymeric substrate alone (including any sublayers that may be present). Alternatively, the free shrink of the polymeric substrate may be measured on a combination of the polymeric substrate and the polymeric buffer layer, plus any intervening layers, together. The free shrink of the polymeric substrate may be measured when the polymeric substrate is connected to the inorganic coating, including the polymeric buffer layer and any other intervening layers.

The polymeric substrate comprises any polymer including, but not limited to polyethylene polymer, polypropylene polymer, polyethylene terephthalate polymer, polyethylene naphthalate polymer, polyamide polymer, polyvinyl chloride polymer, polylactic acid polymer, polyvinylidene fluoride polymer, polychlorotrifluoroethylene polymer or polybutylene succinate polymer or blends of these polymers. The polymeric substrate may comprise any number of sublayers. The sublayers of the polymeric substrate may include polymers within the same polymer class (i.e., all layers are various types of polypropylene polymers) or the sublayers may be of different polymer classes. The polymeric substrate may be oriented or non-oriented. The polymeric substrate may be relatively clear, translucent, or opaque.

The polymeric substrate may be a monolayer or multilayer film (e.g., a blown film or cast film) and the monolayer or multilayer film may be produced by any process known to the skilled artisan, such as coating, extrusion, coextrusion or lamination. In some embodiments, the polymeric substrate comprises one or more of an oriented polyethylene (OPE) film, an oriented polyethylene terephthalate (OPET) film, an oriented polyethylene naphthalate (OPEN) film, an oriented polypropylene (OPP) film, a biaxially oriented polyethylene (BOPE) film, a biaxially oriented polyethylene terephthalate (BOPET) film, or a biaxially oriented polypropylene (BOPP) film. In some embodiments, the polymeric substrate comprises one or more of a machine direction oriented polyethylene (MDOPE) film or a machine direction oriented polypropylene (MDOPP) film. In some embodiments, the polymeric substrate comprises one or more of an oriented polyethylene naphthalate (PEN) film or an oriented polyactic acid (OPLA) film. In some embodiments, the polymeric substrate may be produced using specific polymers and may be oriented using specific conditions which optimize the heat resistance of the film.

In some embodiments, the inorganic coating 13, 23, 33, 43 has a thickness 13A, 23A measured in the z-direction. In one or more embodiments, the inorganic coating 13, 23, 33, 43 has a thickness 13A, 23A in a range of from 5 nm to 200 nm, in a range of from 5 nm to 60 nm, in a range of from 10 nm to 100 nm, or in a range of from 10 nm to 60 nm. Without intending to be bound by any particular theory of operation, an inorganic coating having a thickness greater than these ranges may result in a layer that is not able to flex into the wave structure to accommodate the surface area change without cracking or otherwise failing.

In one or more embodiments, the inorganic coating of the film structure comprises one or more of an oxide, a metal oxide, a nitride, or a metal nitride. In some embodiments, the inorganic coating comprises one or more of aluminum (Al) or silicon (Si). In some embodiments, the inorganic coating comprises an alloy of aluminum (Al) and any suitable metal oxide known to the skilled artisan. In some embodiments, the inorganic coating comprises an alloy of silicon (Si) and any suitable metal oxide known to the skilled artisan. In some embodiments, the inorganic coating comprises or more of a transparent oxide coating such as aluminum oxide (AlOx) or silicon oxide (SiOx).

In some embodiments, the inorganic coating comprises a metal oxide that is configured to block ultraviolet (UV) light. Without intending to be bound by any particular theory, it is believed that UV blocking materials have mainly positive effects on the different plant physiological functions, such as photosynthesis and transpiration rate, and on plant growth characteristics. In some embodiments, the metal oxide that is configured to block (UV) light includes, but is not limited to, one or more of zinc oxide (ZnOx), titanium dioxide (TiO₂), tungsten oxide (WOx), indium tin oxide (ITO), or cerium oxide (CeOx). The inorganic coating may comprise any transparent ceramic known to the skilled artisan, including but not limited to, an oxide, a nitride, or a carbide. In some embodiments, the inorganic coating comprises silicon nitride (SiNx). In some embodiments, the inorganic coating comprises silicon oxynitride (SiOxNx). The inorganic coating may comprise any suitable silicon-metal oxide known to the skilled artisan. In some embodiments, the inorganic coating comprises silicon zinc oxide (SiZnOx). In some embodiments, the inorganic coating comprises silicon oxide (SiOx). In some embodiments, the inorganic coating comprises aluminum oxide (AlOx).

The inorganic coating may be applied by any suitable process known to the skilled artisan. In some embodiments, the inorganic coating is applied by a vacuum deposition process, such as chemical vapor deposition or physical vapor deposition. Alternatively, the inorganic coating may be applied using a wet chemistry technique. In some embodiments, the inorganic coating is deposited on the surface of the polymeric buffer layer. In some embodiments, the inorganic coating is directly adjacent to and in direct contact with the polymeric buffer layer.

The inventors have surprisingly found that a film structure could be developed to incorporate the formation of a wave structure in the inorganic coating upon heating of the film structure. Upon heating, the film structure maintains the performance properties necessary for these film structures to be used in, for example, greenhouse screens. For instance, the layers necessary for wave formation are also able to include necessary bonding to adjacent layers, have appropriate flexibility and clarity, and provide durability through other environmental conditions beyond thermal exposure (i.e., flexing, puncture, humidity, etc.).

The lacquer 25, 45 has a thickness 25A measured in the z-direction. In one or more embodiments, the lacquer 25, 45 has a thickness 25A in a range of from 0.1 μm to 0.95 μm or from 0.5 μm to 0.9 μm, or in a range of from 0.6 μm to 0.8 μm. Without intending to be bound by any particular theory of operation, a lacquer having a thickness greater than these ranges may result in a layer that is not able to flex into the wave structure to accommodate the surface area change without cracking or otherwise failing.

The polymeric buffer layer 14, 24, 34, 44 has a thickness 14A, 24A measured in the z-direction. In one or more embodiments, the polymeric buffer layer 14, 24, 34, 44 has a thickness 14A, 24A in a range of from 0.5 μm to 9 μm, in a range of from 1 μm to 5 μm, or in a range of from 1 μm to 2.5 μm.

In some embodiments, the polymeric buffer layer adjacent to the inorganic coating conforms to a wave structure to accommodate for the unchanging surface area of the inorganic coating. Without intending to be bound by any particular theory of operation, a relationship between the polymeric buffer layer and the inorganic coating may be described with reference to a ratio of the thickness of the polymeric buffer layer to the thickness of the inorganic coating. In some embodiments, the ratio of the thickness of the polymeric buffer layer to the thickness of the inorganic coating is in a range of from 20 to 500, or in a range of from 30 to 120. The inventors have discovered that a ratio of thicknesses of the polymeric buffer layer to the thickness of the inorganic coating within the ranges described herein is one of a plurality of factors that allow for formation of a wave structure in the inorganic coating upon shrinking of the polymeric substrate.

In some embodiments, the polymeric buffer layer has a Young's modulus in a range of from 0.1 MPa to 100 MPa as calculated from measurements collected at 95° C., according to ASTM E2546-15 with Annex X.4. In some embodiments, the polymeric buffer layer has a Young's modulus in a range of from 0.1 MPa to 100 MPa as calculated from measurements collected at the shrink onset temperature of the polymeric substrate, according to ASTM E2546-15 with Annex X.4. The Young's modulus of the polymeric buffer layer at the elevated temperature, in conjunction with the location and thickness of the polymeric buffer layer among other details of the film structure, advantageously allows for the formation of the wave structure in the inorganic coating as the polymeric substrate shrinks without cracks (or without as many cracks).

In one or more embodiments, the film structure may have a total thickness in a range of from about 6 μm to about 60 μm. As used herein, the total thickness of film structure includes the thickness of the polymeric substrate, the polymeric buffer layer, the inorganic coating and any other layers attached to these. In some embodiments, the minimum total thickness of the film structure is about 8 μm. In some embodiments, the minimum total thickness of the film structure is about 10 μm. In some embodiments, the maximum total thickness of the film structure is about 25 μm. In some embodiments, the maximum total thickness of the film structure is about 19 μm. As used herein, the total thickness refers to the combined thickness of each layer/film in the film structure.

As previously described herein, an increase in environmental temperature may cause the polymeric substrate to shrink slightly in one or more directions. As the temperature rises, the polymeric material softens, releasing tension that may have been embedded in the layer upon production. The tension release may result in a movement and rearrangement of the polymer chains and an ultimate change (increase or decrease) in the dimensions of the layer. A common result of increasing temperature on a polymeric substrate is a slight reduction (i.e., shrink) of the polymeric substrate in at least one direction parallel with the x-y plane of the layer.

Upon shrinking of the polymeric substrate, a compressive force is applied to the other layers within the film structure, with the largest force being applied to the adjacent layers. The other layers may also have a shrinking tendency at the elevated temperature, and it is likely that the free shrink of each layer is slightly different. The greatest difference in free shrink is likely found when comparing any polymeric layer to the inorganic coating of the film structure. Without intending to be bound by any particular theory of operation, it is believed that most inorganic coatings do not experience shrink at the temperatures at which the polymeric substrate will shrink (e.g., 95° C. or another suitable temperature). Additionally, inorganic coatings also have very high modulus (high stiffness) at elevated temperatures (e.g., 95° C.).

The wave structure may be formed when the film structure is exposed to temperatures greater than or equal to 95° C. The wave structure may be formed when the film structure is exposed to temperatures greater than or equal to the shrink onset temperature of the polymeric substrate. For example, the film structure may be heated by a roller or an oven on equipment suited for roll-to-roll film converting. The roller should be heated to a temperature that is capable of raising the temperature of the film structure, causing the wave formation to occur.

Using one or more embodiments of the film structures described herein, upon experiencing an elevated temperature, the polymeric substrate, and possibly other layers of the structure, will begin to shrink. In some embodiments, the closely located polymeric buffer layer, having a low modulus at the elevated temperature, experiences the x-y direction compressive force and conforms to the stress easily. The surface of the polymeric buffer layer may become slightly denser, or the polymeric buffer layer may become slightly thicker (z-direction) as the surface area (x-y direction) of the polymeric substrate decreases and the material polymeric buffer layer is compressed. The inorganic coating, however, is not pliable (i.e., has high modulus and high stiffness). As a result of the x-y direction compressive forces from the shrinking polymeric substrate, and the low modulus of the underlying (i.e., directly adjacent) polymeric buffer layer, the inorganic coating may have a tendency bend into a pattern of waves, the amplitude of the waves forming in the z-direction. The formation of the wave structure preserves the surface area of the inorganic coating, preventing the typical cracks that may normally form under the shrink forces in the absence of an appropriate polymeric buffer layer.

The inventors have discovered that aspects of the wave structure can be modified according to certain variables described in Huang, ZY, Hong, W, Suo Z 2005, ‘Nonlinear Analysis of Wrinkles in a Film Bonded to a Compliant Substrate’, Journal of the Mechanics and Physics of Solids, 53, 2101-2118. Using such variables, the inventors have found that increasing surface area of the inorganic coating having the wave structure depends on the free shrink of the polymeric substrate.

Without being limited to any particular embodiment, the method 500 may be used to form embodiments of the film structure with an inorganic coating having a wave structure as illustrated in any of FIGS. 3-4.

The method 500 comprises, at operation 502, providing a polymeric substrate and positioning a polymeric buffer layer thereon. The polymeric buffer layer may be positioned onto the polymeric substrate by any means, such as, but not limited to, coating a lacquer onto a film, coextrusion of the polymeric buffer layer with the polymeric substrate or extrusion coating the polymeric buffer layer onto a film. At operation 504, the method 500 comprises applying an inorganic coating on a top surface of the polymeric buffer layer. At operation 506, the method 500 comprises heating the polymeric substrate to impart a wave structure to the inorganic coating. At operation 508, the method 500 optionally includes positioning a lacquer on top of the inorganic coating. Optional operation 508 may be before or after imparting of the wave structure occurring at operation 506.

The cross-sectional view shown in FIG. 3 illustrates a film structure 30 which is identical to that shown in FIG. 1, with the exception that the inorganic coating 13 of FIG. 1 has now taken on a wave formation to form inorganic coating 33 including a wave structure. In other words, the precursory film structure 10 of FIG. 1 has been exposed to elevated temperatures (e.g., a temperature higher than the polymeric substrate shrink onset temperature), inducing shrink in the polymeric substrate 12,32.

The film structure 30 includes a polymeric substrate 32, an inorganic coating 33 and a polymeric buffer layer 34 positioned between the polymeric substrate 32 and the inorganic coating 33. In some embodiments, the polymeric buffer layer 34 is in direct contact with the inorganic coating 33. In some embodiments, the polymeric buffer layer 34 may be in direct contact with the polymeric substrate 32, as shown in FIG. 3, or there may be one or more additional layers between the polymeric buffer layer 34 and the polymeric substrate 32. The polymeric substrate 32 forms an exterior layer of the film structure 30 and the inorganic coating 33 forms the opposing exterior layer of the film structure 30.

The cross-sectional view shown in FIG. 4 illustrates a film structure 40 which is identical to that shown in FIG. 2, with the exception that the inorganic coating 23 and lacquer 25 of FIG. 2 have now taken on a wave formation to form inorganic coating 43 and lacquer 45, each having a wave structure. In other words, the film structure 20 of FIG. 20 has been exposed to elevated temperatures (e.g., a temperature exceeding the shrink onset temperature of the polymeric substrate), inducing shrink in the polymeric substrate 22,42.

In FIG. 4, the film structure 40 includes a polymeric substrate 42, an inorganic coating 43 and a polymeric buffer layer 44 (e.g., a first polymeric buffer layer) positioned between the polymeric substrate 42 and the inorganic coating 43. In some embodiments, the polymeric buffer layer 44 (e.g., a first polymeric buffer layer) is in direct contact with the inorganic coating 43. In some embodiments, the polymeric buffer layer 44 (e.g., a first polymeric buffer layer) may be in direct contact with the polymeric substrate 42, as shown in FIG. 4, or there may be one or more additional layers between the polymeric buffer layer 44 (e.g., a first polymeric buffer layer) and the polymeric substrate 42. In FIG. 4, the film structure 40 includes a lacquer 45 directly on the inorganic coating 43. In FIG. 4, the polymeric substrate 42 forms an exterior layer of the film structure 40 and the lacquer 45 having a wave structure forms the opposing exterior layer of the film structure 40.

In some embodiments, the lacquer 25 45 comprises a second polymeric buffer layer. In some embodiments, the second polymeric buffer layer of the lacquer 25 45 is in direct contact with the inorganic coating 23 43, opposite the first polymeric buffer layer 24 44. In some embodiments, the second polymeric buffer layer of the lacquer 25 45 has the same properties as the first polymeric buffer layer 24 44 in regard to one or more of the content, thickness and/or physical properties. In some embodiments, the second polymeric buffer layer of the lacquer 25 45 has different properties as compared to the first polymeric buffer layer 24 44.

An arrow at the bottom of FIGS. 3-4 illustrates the machine direction of the film structure. In these Figures, the plurality of waves in the wave structure of the inorganic coating 33 43 are formed in the machine direction. In other embodiments of the film structures (not shown), the waves may be formed in the transverse direction. In other embodiments of the film structures, the waves may be formed in both the machine direction and the transverse direction.

The wave structures shown in FIGS. 3-4 are characterized by an average amplitude 33B, 43B and a wavelength 33C, 43C. In some embodiments, the average amplitude 33B, 43B of the wave structure may be in a range of from 0.1 μm to 5 μm, in a range of from 0.2 μm to 0.6 μm, in a range of from 0.5 μm to 4 μm, in a range of from 1 μm to 3.5 μm, or in a range of from 2 μm to 3 μm. In some embodiments, the wavelength 33C, 43C of the wave structure may be in a range of from 0.3 μm to 15 μm, in a range of from 1 μm to 10 μm, in a range of from 1 μm to 5 μm, in a range of from 2 μm to 8 μm, or in a range of from 4 μm to 6 μm. In some embodiments, the wave structure may also be characterized by a ratio of the wavelength 33C, 43C to the average amplitude 33B, 43B in a range of from 2 to 20, or in a range of from 4 to 10. In the illustrated embodiment of FIG. 4, the lacquer 45 has a wave structure. In the illustrated embodiment of FIG. 4, the lacquer 45 is characterized by an average amplitude 45B and a wavelength 45C. In some embodiments, the average amplitude 45B and the wavelength 45C of the lacquer 45 may be the same as the average amplitude 43B and the same wavelength 43C of the inorganic coating 43.

In some embodiments, the thickness of the polymeric buffer layer may be in a range of from 1.1 to 20 times the average amplitude 33B, 43B of the wave structure. In some embodiments, the thickness of the polymeric buffer layer may be in a range of from 1.5 to 5 times the average amplitude 33B, 43B of the wave structure.

In embodiments where the film structure includes a wave structure formed in the inorganic coating, the thickness of the polymeric buffer layer may vary along the length of the wave (i.e., the wavelength). In such embodiments, the thickness of the polymeric buffer layer is measured at the center point (i.e., a center point of the wave being between the crest and the trough of the wave).

In some embodiments, when the inorganic coating has the wave structure, the film structure has a transparency of at least 85% measured using the method disclosed in ASTM D-1003. In some embodiments, the transparency is at least 90% measured using the method disclosed in ASTM D-1003. In some embodiments, when the inorganic coating has the wave structure, wherein the film structure has a haze value of at least 60% measured using the method disclosed in ASTM D-1003. In some embodiments, the haze value is at least 65%, at least 70%, at least 75%, at least 80%, at least 85%, or at least 90% measured using the method disclosed in ASTM D-1003.

In some embodiments, when the inorganic coating has the wave structure, clarity of the film structure is measured by calculating a percentage of light rays that are diffracted at an angle of less than or equal to 2.5 degrees from normal.

Without intending to be bound by any particular theory of operation, it is believed that when clarity is high, a significant amount of light is diffracted at a small angle, thereby leading to a poor hortiscatter value. As used herein, “hortiscatter value” refers to how the light that penetrates a surface is spread from each penetration point. Hortiscatter value is between 0% for clear glass and 100% for material that spreads penetrating light evenly across all points. Without intending to be bound by any particular theory of operation, it is believed that the greater the hortiscatter value, the higher the light diffusion. Accordingly, film structures described herein having a high hortiscatter value may, advantageously, refract the highly diffuse light from the sun to improve the total flux of light arriving across the growing plants in a greenhouse, for example, thereby improving growing efficiency. The film structures disclosed herein may provide hortiscatter values above 50%, or in the range of from 50% to 90%, or in a range of from 50% to 75%, or in a range of from 50% to 60%. This may be compared to typical greenhouse films which may provide hortiscatter values around 35%.

The disclosure is now described with reference to the following examples.

### EXAMPLES AND DATA

Several film structures were produced as described below and the optical properties are summarized in Tables 1-4.

TABLE 1
Example Film Structure 1 Optical Properties

| | Average | Average Haze | |
|---|---|---|---|
| Temperature | Transparency (%) | (%) | Average Clarity (%) |
| 150° C.; 5 min | 88.0% | 85.4% | 69.8% |
| 170° C.; 5 min | 89.7% | 86.8% | 64.2% |
| 190° C.; 5 min | 96.2% | 95.7% | 43.8% |
| 210° C.; 5 min | 90.6% | 98.1% | 5.1% |

In Example Film Structure 1, the polymeric substrate comprises a SKC-SL80 material (SKC Skyrol® SL80C biaxially oriented PET film, available from SMP Corporation), has a thickness of 12.5 μm, and has free shrink values of 3.5% in machine direction (MD) and 1.5% transverse direction (TD), measured at 150° C. after 30 min. The polymeric buffer layer is a water-based polyurethane dispersion, applied to the polyester film by coating and dried, having a final thickness of 1.7 μm, and a Young's Modulus at 95° C. of 27 MPa, as calculated according to ASTM E2546-15 with Annex X.4. The inorganic coating is silicon oxide, applied by vapor deposition to the polymeric buffer layer surface.

TABLE 2
Example Film Structure 2 Optical Properties

| | Average | Average Haze | |
|---|---|---|---|
| Temperature | Transparency (%) | (%) | Average Clarity (%) |
| 150° C.; 5 min | 91.5% | 7.5% | 87.0% |
| 170° C.; 5 min | 90.2% | 9.1% | 85.7% |
| 190° C.; 5 min | 90.5% | 12.0% | 83.8% |
| 210° C.; 5 min | 91.4% | 32.1% | 76.6% |

In Example Film Structure 2, the polymeric substrate is a biaxially oriented PET film, has a thickness of 13 μm, and has free shrink values of 4% in machine direction (MD) and 1% in transverse direction (TD), measured at 190° C. after 5 min. The polymeric buffer layer is a copolyester, which is a layer within the OPET film. The inorganic coating is silicon oxide, applied by vapor deposition to the surface of the polymeric buffer layer.

TABLE 3
Example Film Structure 3 Optical Properties

| | Average | Average Haze | |
|---|---|---|---|
| Temperature | Transparency (%) | (%) | Average Clarity (%) |
| 150° C.; 5 min | 86.5% | 75.2% | 20.7% |
| 170° C.; 5 min | 86.9% | 81.3% | 16.3% |
| 190° C.; 5 min | 88.5% | 83.3% | 15.3% |
| 210° C.; 5 min | 90.4% | 91.2% | 9.4% |

In Example Film Structure 3, the polymeric substrate is a biaxially oriented PET film, has a thickness of 12 μm, and has free shrink values of 3% in machine direction (MD) and 3% in transverse direction (TD), measured at 190° C. after 5 min. The polymeric buffer layer is a water-based polyurethane dispersion, applied to the polyester film by coating and dried, having a final thickness of 1.7 μm, and a Young's Modulus at 95° C. of 27 MPa, as calculated according to ASTM E2546-15 with Annex X.4. The inorganic coating is silicon oxide, applied to the surface of the polymeric buffer layer by vapor deposition.

TABLE 4
Example Film Structure 4 Optical Properties

| | Average | Average Haze | |
|---|---|---|---|
| Temperature | Transparency (%) | (%) | Average Clarity (%) |
| 150° C.; 5 min | 88.6% | 64.3% | 83.2% |
| 170° C.; 5 min | 88.0% | 70.9% | 81.2% |
| 190° C.; 5 min | 89.1% | 80.7% | 78.0% |
| 210° C.; 5 min | 91.7% | 83.6% | 72.1% |

In Example Film Structure 4, the polymeric substrate is a Hostaphan® RUF film (available from Mitsubishi Polyester Film GmbH), has a thickness of 19 μm, and has free shrink values of 1.8% in machine direction (MD) and 0.7% in transverse direction (TD), measured at 150° C. after 15 min. The polymeric buffer layer is a water-based polyurethane dispersion, applied to the polyester film by coating and dried, having a final thickness of 1.7 μm, and a Young's Modulus at 95° C. of 27 MPa, as calculated according to ASTM E2546-15 with Annex X.4. The inorganic coating is silicon oxide, applied to the polymeric buffer layer by vapor deposition.

For each of the Example Film Structures 1-4, the process to shrink the film structure and create the waves, included a roll-to-roll process having heated rollers. Variables of roll temperature, line speed and tension control are set to heat the polymeric substrate such that it will shrink. The inventors used an annealing unit for an MDO line. Any other suitable equipment known to the skilled artisan could be used for heating, such as an oven in a laminating or coating operation. Shrink can be induced by any suitable process known to the skilled artisan.

The inventors have discovered that the Example Film Structures 1-4 exhibit improved optical properties with respect to average transparency and average haze as measured using the method disclosed in ASTM D-1003, and clarity of the film structure, which is measured by calculating a percentage of light rays that are diffracted at an angle of less than or equal to 2.5 degrees from normal.

Optical data was collected for comparison of an example film to a reference film. The reference film was 19 μm Hostaphan® RUF film (available from Mitsubishi Polyester Film GmbH) which is a UV stable polyester film. The example film tested was the same polyester film with a polymeric buffer layer and inorganic coating added, heat treated in a roll-to-roll process to a temperature of 130° C. BSDF (bidirectional scattering distribution function) data was collected as a function of angle of light incidence at 630 nm and haze/light transmission measurements were taken.

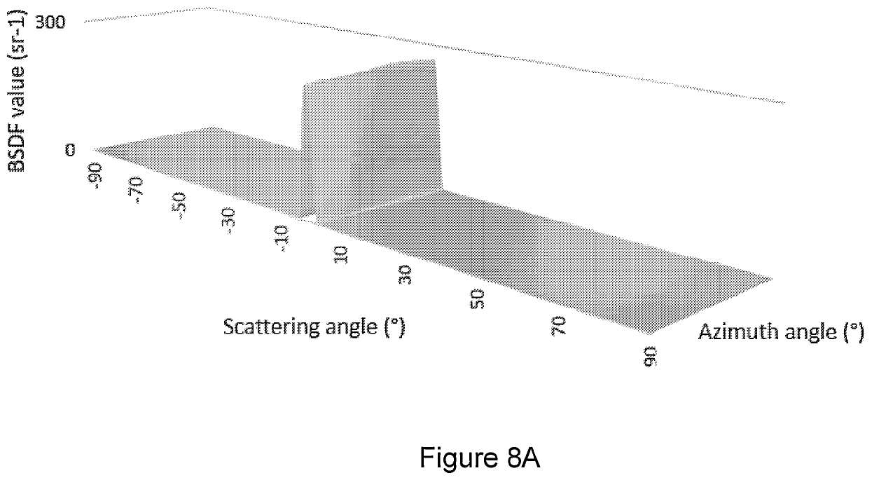

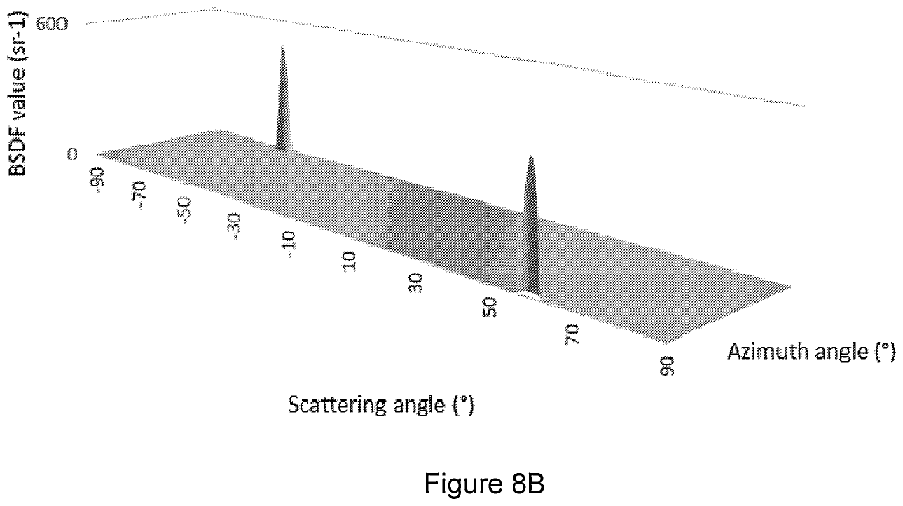

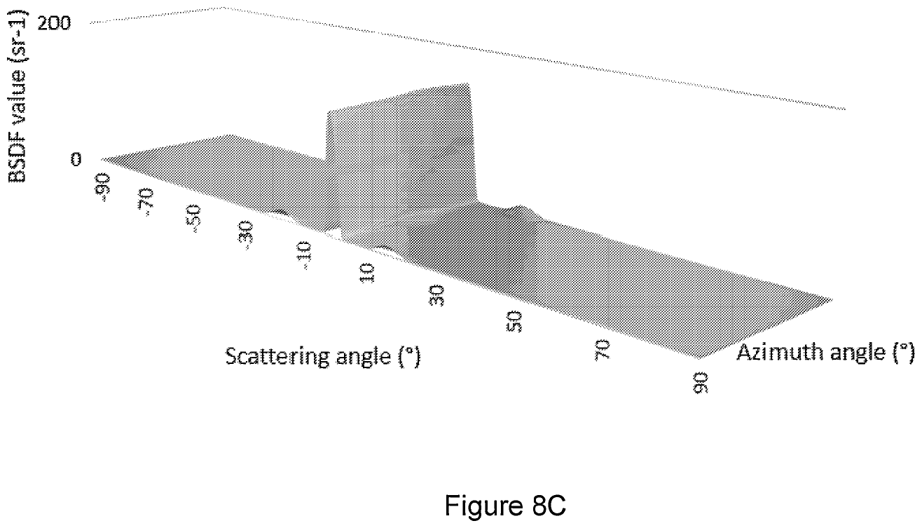

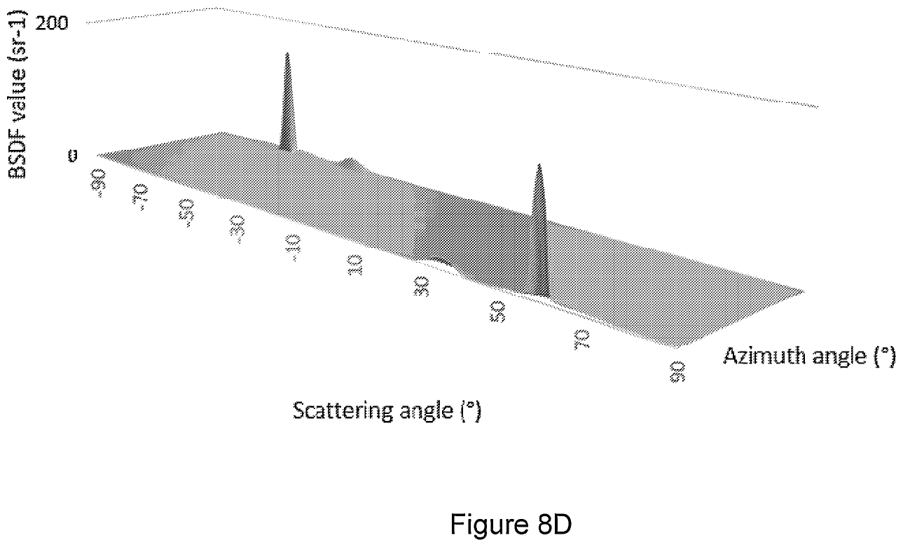

The BSDF data is shown in FIGS. 8A through 8D. FIG. 8A is the result of testing the reference film at an incident light angle of 0°. Of note is that the transmitted light is narrowly distributed around 0°, showing very little light scattering. FIG. 8B is the result of testing the reference film at an incident light angle of 60°. Here too, the result is tall narrow peaks around 60°, indicating very little light scattering. Comparatively, FIGS. 8C and 8D show the results of testing the example film at 0° and 60°, respectively. In FIG. 8C, the transmitted light at 0° is lower and there are several broad peaks at other angles (between 10° and 30°). Similarly, in FIG. 8D the transmitted light at 60° is lower and there are several broad peaks at other angles (around 30°). Overall, the measurements show that about 35% of the light has been scattered.

Haze and light transmission data for the reference and example films are shown in Table 5. The data shows the very uncommon combination of high haze and high light transmission. In practical application, as light travels through the example film, the light is highly scattered and scattered in a way that more of the light is transmitted and less is reflected.

TABLE 5
Haze and Transmission Data in Comparison

| | Light | |
|---|---|---|
| | Transmission | Haze |
| Film | (%) | (%) |
| Reference Film | 90.4% | 3% |
| Example Film | 92.0% | 70% |

### EMBODIMENTS

Embodiment 1: A film structure comprising: a polymeric substrate having an inorganic coating thereon; and a polymeric buffer layer positioned between the polymeric substrate and the inorganic coating, wherein the inorganic coating comprises a wave structure characterized by an average amplitude in a range of from 0.1 μm to 5 μm and a wavelength in a range of from 0.3 μm to 15 μm.

Embodiment 2: The film structure according to Embodiment 1, wherein the polymeric substrate comprises one or more of polyethylene polymer, polypropylene polymer, polyethylene terephthalate polymer, polyethylene naphthalate polymer, polyamide polymer, polyvinyl chloride polymer, polylactic acid polymer, polyvinylidene fluoride polymer, polychlorotrifluoroethylene polymer or polybutylene succinate polymer.

Embodiment 3: The film structure according to Embodiment 1, wherein the polymeric substrate comprises an oriented polyethylene film, an oriented polyester film, an oriented polyamide film, an oriented polylactic acid polymer film, a polyvinyl chloride film, a fluorinated polymer film or an oriented polybutylene succinate film.

Embodiment 4: The film structure according to any previous embodiment, wherein the polymeric substrate comprises a thickness in a range of from 5 μm to 100 μm.

Embodiment 5: The film structure according to any previous embodiment, wherein the inorganic coating comprises a thickness in a range of from 5 nm to 200 nm.

Embodiment 6: The film structure according to any previous embodiment, wherein the polymeric buffer layer comprises a thickness in a range of from 0.5 μm to 9 μm.

Embodiment 7: The film structure according to any previous embodiment, wherein a ratio of the thickness of the polymeric buffer layer to the thickness of the inorganic coating is in the range of from 30 to 120.

Embodiment 8: The film structure according to any previous embodiment, wherein the polymeric buffer layer comprises a Young's Modulus in a range of 0.1 MPa to 100 MPa, as calculated from measurements collected at 95° C., according to ASTM E2546-15 with Annex X.4.

Embodiment 9: The film structure according to any one of Embodiments 1-7, wherein the polymeric buffer layer comprises a Young's Modulus in a range of 0.1 MPa to 100 MPa, as calculated from measurements collected at or above a shrink onset temperature of the polymeric substrate, according to ASTM E2546-15 with Annex X.4.

Embodiment 10: The film structure according to any previous embodiment, wherein the polymeric buffer layer comprises one or more of a vinyl alcohol copolymer, a polyolefin-based polymer, a polyurethane-based polymer, an acrylic polymer, a polyester-based polymer, a polyepoxide-based polymer or polylactic acid polymer.

Embodiment 11: The film structure according to any previous embodiment, wherein the inorganic coating comprises one or more of chromium, palladium, an oxide, a metal oxide, a nitride, or a metal nitride.

Embodiment 12: The film structure according to any one of Embodiments 1-10, wherein the inorganic coating is a metal oxide configured to block ultraviolet (UV) light.

Embodiment 13: The film structure according to any one of Embodiments 1-10, wherein the inorganic coating comprises silicon oxide.

Embodiment 14: The film structure according to any previous embodiment, wherein the inorganic coating has a refractive index in a range of from 1.2 to 5.

Embodiment 15: The film structure according to any previous embodiment, wherein the wave structure comprises a plurality of waves formed in one or more of a machine direction and a transverse direction.

Embodiment 16: The film structure according to any previous embodiment, wherein the film structure has a transparency of at least 85% measured using the method disclosed in ASTM D-1003.

Embodiment 17: The film structure according to any previous embodiment, wherein the film structure has a haze value of at least 60% measured using the method disclosed in ASTM D-1003.

Embodiment 18: The film structure according to any previous embodiment, further comprising a lacquer on a surface of the inorganic coating.

Embodiment 19: The film structure according to Embodiments 17 through 18, wherein the lacquer has a thickness in a range of from 0.5 μm to 0.9 μm.

Embodiment 20: The film structure according to Embodiment 18, wherein the polymeric buffer layer is a first polymeric buffer layer, and the lacquer comprises a second polymeric buffer layer.

Embodiment 21: The film structure according to Embodiment 20, wherein the second polymeric buffer layer of the lacquer has the same properties as the first polymeric buffer layer.

Embodiment 22: A method of forming a film structure, the method comprising: providing a polymeric substrate having a shrink onset temperature at which the polymeric substrate has a free shrink of at least 0.5% in at least one of a machine direction or a transverse direction when measured according to ASTM D2732; positioning a polymeric buffer layer on a surface of the polymeric substrate; positioning an inorganic coating on a surface of the polymeric buffer layer such that the polymeric buffer layer is between the polymeric substrate and the inorganic coating; and heating the polymeric substrate to a temperature above the shrink onset temperature to impart a wave structure to the inorganic coating, the wave structure of the inorganic coating characterized by an average amplitude in a range of from 0.1 μm to 5 μm and a wavelength in a range of from 0.3 μm to 15 μm.

Embodiment 23: The method according to Embodiment 22, wherein the polymeric substrate comprises one or more of polyethylene polymer, polypropylene polymer, polyethylene terephthalate polymer, polyethylene naphthalate polymer, polyamide polymer, polyvinyl chloride polymer, polylactic acid polymer, polyvinylidene fluoride polymer, polychlorotrifluoroethylene polymer or polybutylene succinate polymer.

Embodiment 24: The method according Embodiment 22, wherein the polymeric substrate comprises an oriented polyethylene film, an oriented polyester film, an oriented polyamide film, an oriented polylactic acid polymer film, a polyvinyl chloride film, a fluorinated polymer film or an oriented polybutylene succinate film.

Embodiment 25: The method according to any one of Embodiments 22 through 24, wherein the polymeric substrate comprises a thickness in a range of from 5 μm to 100 μm.

Embodiment 26: The method according to any one of Embodiments 22 through 25, wherein the inorganic coating comprises a thickness in a range of from 5 nm to 200 nm.

Embodiment 27: The method according to any one of Embodiments 22 through 26, wherein the polymeric buffer layer comprises a thickness in a range of from 0.5 μm to 9 μm.

Embodiment 28: The method according to any one of Embodiments 22 through 27, wherein a ratio of the thickness of the polymeric buffer layer to the thickness of the inorganic coating is in the range of from 30 to 120.

Embodiment 29: The method according to any one of Embodiments 22 through 28, wherein the polymeric buffer layer comprises a Young's Modulus in a range of 0.1 MPa to 100 MPa, as calculated from measurements collected at 95° C., according to ASTM E2546-15 with Annex X.4.

Embodiment 30: The method according to any one of Embodiments 22-29, wherein the polymeric buffer layer comprises a Young's Modulus in a range of 0.1 MPa to 100 MPa, as calculated from measurements collected at or above the shrink onset temperature of the polymeric substrate, according to ASTM E2546-15 with Annex X.4.

Embodiment 31: The method according to any one of Embodiments 22 through 30, wherein the polymeric buffer layer comprises one or more of a vinyl alcohol copolymer, a polyolefin-based polymer, a polyurethane-based polymer, an acrylic polymer, a polyester-based polymer, a polyepoxide-based polymer or polylactic acid polymer.

Embodiment 32: The method according to any one of Embodiments 22-31, wherein the inorganic coating comprises one or more of chromium, palladium, an oxide, a metal oxide, a nitride, or a metal nitride.

Embodiment 33: The method according to any one of Embodiments 22-31, wherein the inorganic coating is a metal oxide configured to block ultraviolet (UV) light.

Embodiment 34: The method according to any one of Embodiments 22-31, wherein the inorganic coating comprises silicon oxide.

Embodiment 35: The method according to any one of Embodiments 22-34, wherein the inorganic coating has a refractive index in a range of from 1.2 to 5.

Embodiment 36: The method according to any one of Embodiments 22-35, wherein the wave structure comprises a plurality of waves formed in one or more of a machine direction and a transverse direction.

Embodiment 37: The method according to any one of Embodiments 22-36, wherein the film structure has a transparency of at least 85% measured using the method disclosed in ASTM D-1003.

Embodiment 38: The method according to any one of Embodiments 22-37, wherein the film structure has a haze value of at least 60% measured using the method disclosed in ASTM D-1003.

Embodiment 39: The method according to any one of Embodiments 22-38, further comprising positioning a lacquer on a surface of the inorganic coating such that the inorganic coating is positioned between the polymeric buffer layer and the lacquer.

Embodiment 40: The method according to Embodiment 39, wherein the lacquer has a thickness in a range of from 0.1 μm to 0.95 μm.

Embodiment 41: The method according to any one of Embodiments 39-40, wherein the polymeric buffer layer is a first polymeric buffer layer, and the lacquer comprises a second polymeric buffer layer.

Embodiment 42: The method according to Embodiment 41, wherein the second polymeric buffer layer of the lacquer has the same properties as the first polymeric buffer layer.

Embodiment 43: The method according to any one of Embodiments 22-42, wherein the haze value present in the film structure increases as temperature increases, as measured using the method disclosed in ASTM D-1003.

1. A film structure comprising:
a polymeric substrate having an inorganic coating thereon; and
a polymeric buffer layer positioned between the polymeric substrate and the inorganic coating,
wherein the inorganic coating comprises a wave structure characterized by an average amplitude in a range of from 0.1 μm to 5 μm and a wavelength in a range of from 0.3 μm to 15 μm.

2. The film structure according to claim 1, wherein the polymeric substrate comprises one or more of polyethylene polymer, polypropylene polymer, polyethylene terephthalate polymer, polyethylene naphthalate polymer, polyamide polymer, polyvinyl chloride polymer, polylactic acid polymer, polyvinylidene fluoride polymer, polychlorotrifluoroethylene polymer or polybutylene succinate polymer.

3. The film structure according to claim 1, wherein the polymeric substrate comprises an oriented polyethylene film, an oriented polyester film, an oriented polyamide film, an oriented polylactic acid polymer film, a polyvinyl chloride film, a fluorinated polymer film or an oriented polybutylene succinate film.

4. The film structure according to claim 1, wherein the polymeric substrate comprises a thickness in a range of from 5 μm to 100 μm.

5. The film structure according to claim 1, wherein the inorganic coating comprises a thickness in a range of from 5 nm to 200 nm.

6. The film structure according to claim 1, wherein the polymeric buffer layer comprises a thickness in a range of from 0.5 μm to 9 μm.

7. The film structure according to claim 1, wherein a ratio of the thickness of the polymeric buffer layer to the thickness of the inorganic coating is in the range of from 30 to 120.

8. The film structure according to claim 1, wherein the polymeric buffer layer comprises a Young's Modulus in a range of 0.1 MPa to 100 MPa, as calculated from measurements collected at 95° C., according to ASTM E2546-15 with Annex X.4.

9. The film structure according to claim 1, wherein the polymeric buffer layer comprises a Young's Modulus in a range of 0.1 MPa to 100 MPa, as calculated from measurements collected at or above a shrink onset temperature of the polymeric substrate, according to ASTM E2546-15 with Annex X.4.

10. The film structure according to claim 1, wherein the polymeric buffer layer comprises one or more of a vinyl alcohol copolymer, a polyolefin-based polymer, a polyurethane-based polymer, an acrylic polymer, a polyester-based polymer, a polyepoxide-based polymer or polylactic acid polymer.

11. The film structure according to claim 1, wherein the inorganic coating comprises one or more of chromium, palladium, an oxide, a metal oxide, a nitride, or a metal nitride.

12. The film structure according to claim 1, wherein the inorganic coating is a metal oxide configured to block ultraviolet (UV) light.

13. The film structure according to claim 1, wherein the inorganic coating comprises silicon oxide.

14. The film structure according to claim 1, wherein the inorganic coating has a refractive index in a range of from 1.2 to 5.

15. The film structure according to claim 1, wherein the wave structure comprises a plurality of waves formed in one or more of a machine direction and a transverse direction.

16. The film structure according to claim 1, wherein the film structure has a transparency of at least 85% measured using the method disclosed in ASTM D-1003.

17. The film structure according to claim 1, wherein the film structure has a haze value of at least 60% measured using the method disclosed in ASTM D-1003.

18. The film structure according to claim 1, further comprising a lacquer on a surface of the inorganic coating.

19. The film structure according to claim 18, wherein the lacquer has a thickness in a range of from 0.5 μm to 0.9 μm.

20. The film structure according to claim 18, wherein the polymeric buffer layer is a first polymeric buffer layer, and the lacquer comprises a second polymeric buffer layer comprising the same properties as the first polymeric buffer layer.

21-43. (canceled)
